(19) United States
(12) Patent Application Publication
(10) Pub. No.: US 2013/0215339 A1
(43) Pub. Date: Aug. 22, 2013

(54) LCD Module with Projection Function and LCD Device

(71) Applicant: Gang Yu, Shenzhen (CN)

(72) Inventor: Gang Yu, Shenzhen (CN)

(21) Appl. No.: 13/503,994

(22) PCT Filed: Mar. 5, 2012
(86) PCT No.: PCT/CN12/71922

§ 371 Date: Apr. 25, 2012

(30) Foreign Application Priority Data
Feb. 16, 2012 (CN) 201210034171.7

(51) Int. Cl. G02F 1/13357

(52) U.S. Cl. 349/5

(57) ABSTRACT

The invention relates to the field of LCDs, and more particularly to an LCD module with projection function and an LCD device including the LCD module. The LCD module includes a light source, a light guide panel, and a backplane, and further includes a projection module sharing the light source of the LCD module, and a switching mechanism for switching liquid crystal display and projection. The LCD module of the invention is used for liquid crystal display in a usual state, the display mode is changed into a projection mode by the switching mechanism when the size of an LCD screen cannot meet the display requirement, and the projection area is large and can basically meet the requirement. The invention has the advantages of one machine with dual-purpose and convenient operation; in addition, a projector is integrated with the LCD module by the invention, and the light source of the LCD module is shared with the projection module by clever design, thus, a simple structure is obtained, and the cost of the device is well controlled.

### TECHNICAL FIELD

The invention relates to the field of liquid crystal displays (LCDs), and more particularly to an LCD module with projection function and an LCD device comprising the LCD module.

### BACKGROUND

Conventional LCDs have small size in general, and are usually used as computer displays, TV and the like. When some large scale conferences, multimedia teaching, home theaters require large display screens, people usually employ projectors. However, the conventional projectors must be connected with computers to achieve large screen display, which is troublesome, and can only provide a single projection function.

The patent application with Application Number of 02225468.4 and Title of multipurpose LCD projector discloses an LCD projector capable of being used as an LCD and a high-definition LCD projector with a large screen. The projector includes two light sources, namely an LCD lamp tube and a projector lamp bulb; the cost of the projector is high because of the two light sources; in addition, because the heat productivity of the projector lamp bulb is large, a high-speed centrifugal fan is required to dissipate heat, causing the whole projector to be in a complicated structure and large volume.

### SUMMARY

The aim of the invention is to provide an LCD module with projection function and an LCD device comprising the LCD module. The LCD module has a simple structure, and shares the light source of the LCD module in projection.

The purpose of the invention is achieved by the following technical scheme.

An LCD module with projection function comprises a light source, a light guide panel, and a backplane, and further comprises a projection module sharing the light source of the LCD module, and a switching mechanism for switching light to the projection module.

Preferably, the switching mechanism comprises a reflecting layer for reflecting light supplied by the light source to the projection module back to the light guide panel, and a driving mechanism for controlling the position of the reflecting layer.

Preferably, the reflecting layer of the switching mechanism is driven by the driving mechanism to move between the projection module and the light guide panel, to block light or release light.

Preferably, the projection module is arranged parallelly to the screen of the LCD module.

Preferably, the projection module is arranged perpendicularly to the screen of the LCD module, the backplane is provided with a transparent hole, and light is supplied by the light guide panel to the projection module through the transparent hole.

Preferably, the position of the light guide panel corresponding to the projection module is provided with a chamfer, and the chamfer and the side of the light guide panel are provided with a reflecting layer.

Preferably, the chamfer of the light guide panel is arranged in a non-visual zone.

Preferably, the driving mechanism of the reflecting layer is a manual shift lever, and the reflecting layer is arranged on the manual shift lever.

Preferably, the driving mechanism of the reflecting layer comprises a pair of interworking rack and gear; the reflecting layer is arranged on the rack, and the rack and the reflecting layer are driven by the rotation of the gear to move.

Preferably, the rack is slidably arranged on the backplane.

Preferably, the backplane is a metal backplane; the metal backplane is riveted with a fixing column, and the gear is fixed on the fixing column.

Preferably, the backplane is a plastic backplane; the plastic backplane is integrated with a fixing column, and the gear is fixed on the fixing column.

The invention further discloses an LCD device, comprising: an LCD module; the LCD module comprises a light source, a light guide panel, and a backplane, and further comprises a projection module sharing the light source of the LCD module, and a switching mechanism for switching light to the projection module.

Preferably, the switching mechanism comprises a reflecting layer for reflecting the light supplied by the light source to the projection module back to the light guide panel, and a driving mechanism for controlling the position of the reflecting layer.

Preferably, the reflecting layer of the switching mechanism is driven by the driving mechanism to move between the projection module and the light guide panel, to block light or release light.

Preferably, the projection module is arranged parallelly to the screen of the LCD module.

Preferably, the projection module is arranged perpendicularly to the screen of the LCD module, the backplane is provided with a transparent hole, and light is supplied by the light guide panel to the projection module through the transparent hole.

Preferably, the position of the light guide panel corresponding to the projection module is provided with a chamfer, and the chamfer and the side of the light guide panel are provided with a reflecting layer.

Preferably, the chamfer of the light guide panel is arranged in a non-visual zone.

Preferably, the driving mechanism of the reflecting layer is a manual shift lever, and the reflecting layer is arranged on the manual shift lever.

Preferably, the driving mechanism of the reflecting layer comprises a pair of interworking rack and gear; the reflecting layer is arranged on the rack, and the rack and the reflecting layer are driven by the rotation of the gear to move.

Preferably, the rack is slidably arranged on the backplane.

Preferably, the backplane is a metal backplane; the metal backplane is riveted with a fixing column, and the gear is fixed on the fixing column.

Preferably, the backplane is a plastic backplane, the plastic backplane is integrated with a fixing column, and the gear is fixed on the fixing column.

Advantages of the invention are summarized below: the LCD module with projection function is employed by the LCD device of the invention. The LCD module is used for liquid crystal display in a usual state, the display mode is changed into a projection mode by the switching mechanism when the size of an LCD screen cannot meet the display requirement, the projection area is large, and can basically meet the requirement. The invention has the advantages of one machine with dual-purpose and convenient operation; in addition, a projector is integrated with the LCD module by the invention, and the light source of the LCD module is shared with the projection module by clever design, thus, a simple structure is obtained, and the cost of the device is well controlled.

### BRIEF DESCRIPTION OF FIGURES

FIG. 1 is a structure diagram of an LCD module of a first example of the invention;

FIG. 2 is a three-dimensional diagram of an LCD module of the first example of the invention;

FIG. 3 is an enlarged view of a switching mechanism of an LCD module of the first example of the invention; and

FIG. 4 is a structure diagram of an LCD module of a second example of the invention.

Wherein: 1. light source; 2. light guide panel; 21. chamfer; 3. backplane; 31. transparent hole; 32. fixing column; 4. projection module; 5. switching mechanism; 51. reflecting layer; 52. driving mechanism; 521. rack; 522. gear.

### DETAILED DESCRIPTION

The invention discloses an LCD device, comprising: an LCD module; the LCD module is an LCD module with projection function, comprises a light source 1, a light guide panel 2, and a backplane 3, and further comprises a projection module 4 sharing the light source of the LCD module, and a switching mechanism 5 for switching light to the projection module 4.

The LCD device of the invention is an LCD TV or an LCD; the LCD module of the invention is used for liquid crystal display in an usual state, the display mode is changed into a projection mode by the switching mechanism 5 when the size of an LCD screen cannot meet the display requirement, and the projection area is large and can basically meet the requirement. The invention has the advantages of one machine with dual-purpose and convenient operation; in addition, a projector is integrated with the LCD module by the invention, and the light source of the LCD module is shared with the projection module by clever design, thus, a simple structure is obtained, and the cost of the device is well controlled.

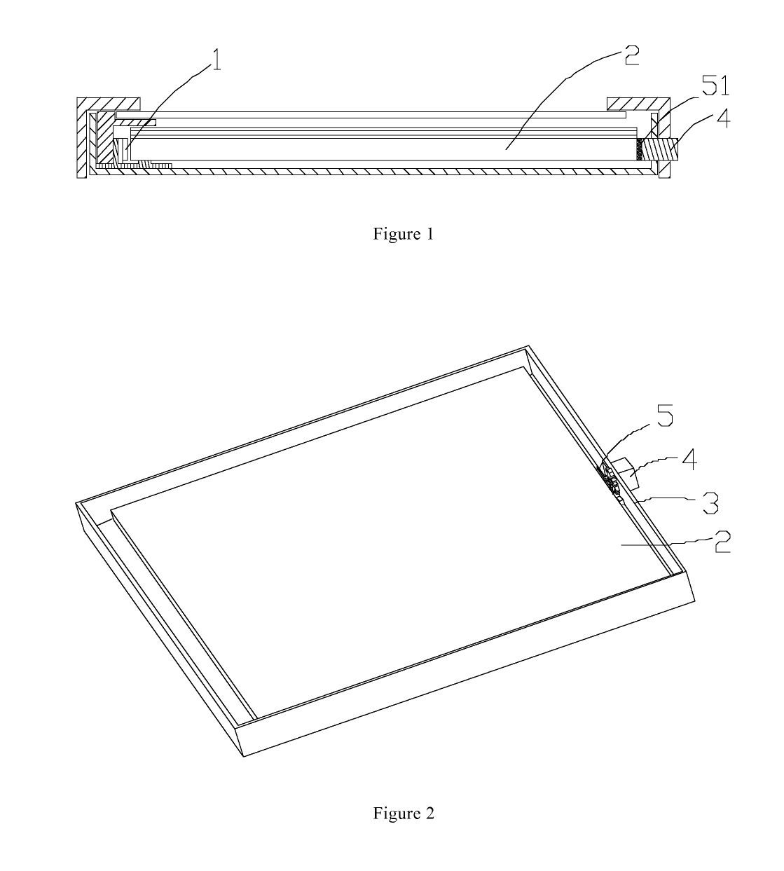

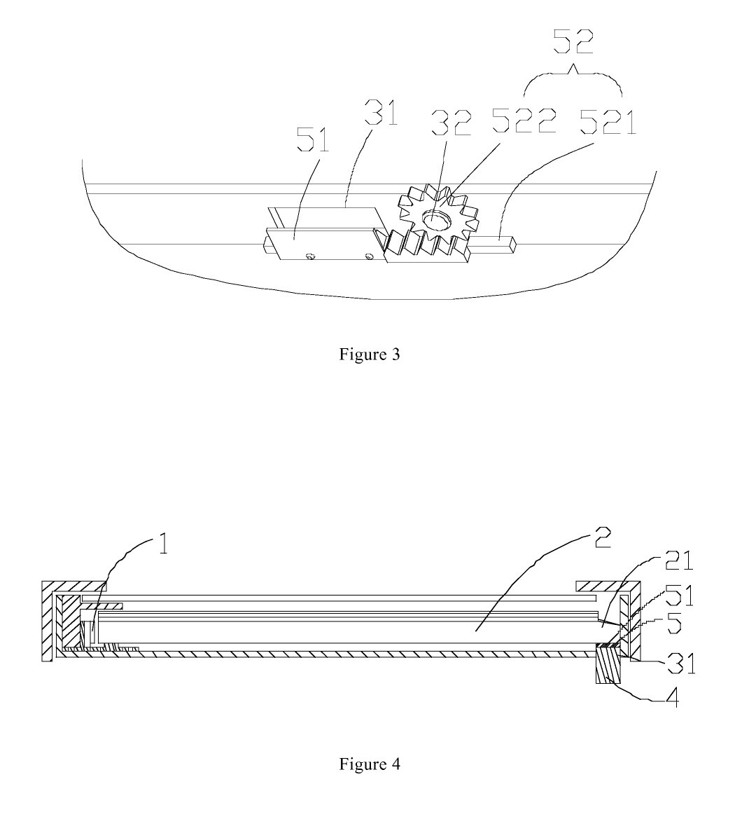

A first example of the LCD module of the invention is shown in FIG. 1 to FIG. 3; the switching mechanism 5 comprises a reflecting layer 51 for reflecting light supplied by the light source 1 to the projection module 4 back to the light guide panel 2, and a driving mechanism 52 for controlling the position of the reflecting layer 51; the reflecting layer 51 can be a reflecting coating layer or a reflecting sheet; the projection module 4 is arranged parallelly to the screen of the LCD module; the reflecting layer 51 of the switching mechanism 5 is driven by the driving mechanism 52 to move between the projection module 4 and the light guide panel 2, to block light or release light.

In the example, the driving mechanism 52 of the reflecting layer 51 comprises a pair of interworking rack 521 and gear 522; the rack 521 is slidably arranged on the backplane 3; the reflecting layer 51 is arranged on the rack 521, and the rack 521 and the reflecting layer 51 are driven by the rotation of the gear 522 to move. When the reflecting layer 51 is in a normal position, the reflecting layer 51 can block the side of the light guide panel 2, and can reflect the light of the light guide panel 2 back to the light guide panel 2; when the reflecting layer 51 is removed, the light of the light guide panel 2 is successfully radiated, and a light source is supplied by the light guide panel 2 to the projection module 4 through the transparent hole 31 in the backplane 3.

In the example, if the backplane 3 is a metal backplane, the metal backplane is riveted with a fixing column 32, and then the gear 522 is fixed on the fixing column 32; if the backplane 3 is a plastic backplane, the plastic backplane is integrated with a fixing column 32, and then the gear 522 is fixed on the fixing column 32.

In the example, the driving mechanism 52 of the reflecting layer 51 can further be a manual shift lever; the reflecting layer 51 is arranged on the manual shift lever, the reflection sheet 51 is moved by manual operation, and thus the switching operation is accomplished.

A second example of the LCD module of the invention is shown in FIG. 4, and the second example is different from the first example in that: the projection module 4 is arranged perpendicularly to the screen of the LCD, the backplane 3 is provided with a transparent hole 31, and light is supplied by the light guide panel 2 to the projection module 4 through the transparent hole 31; the reflecting layer 51 of the switching mechanism is arranged between the projection module 4 and the light guide panel 2, the light of the light guide panel 2 is reflected back to the light guide panel 2 by the reflecting layer 51, and light is supplied by the light guide panel 2 to the projection module 4 through the transparent hole 31 when the reflecting layer 51 is removed by the driving mechanism 52. To increase the light intensity of the projection module 4, the position of the light guide panel 2 corresponding to the projection module 4 is provided with a chamfer 21, the chamfer 21 of the light guide panel 2 is arranged in a non-visual zone, the chamfer 21 and the side of the light guide panel 2 are stuck with a reflecting layer, and the light at the chamfer is reflected by the reflecting layer to the transparent hole, to increase the light intensity of the projection module 4.

In the example, all the switching mechanisms can employ the multiple structures of the first example, which have simple structures and principles, and the example will not give unnecessary details.

The invention is described in detail in accordance with the above contents with the specific preferred examples. However, this invention is not limited to the specific examples. For the ordinary technical personnel of the technical field of the invention, on the premise of keeping the conception of the invention, the technical personnel can also make simple deductions or replacements, and all of which should be considered to belong to the protection scope of the invention.

We claim:

1. An LCD module with projection function, comprising: a light source, a light guide panel, and a backplane, and further comprising a projection module sharing the light source of the LCD module, and a switching mechanism for switching light to the projection module.

2. The LCD module with projection function of claim 1, wherein said switching mechanism comprises a reflecting layer for reflecting light supplied by the light source to the projection module back to the light guide panel, and a driving mechanism for controlling the position of the reflecting layer.

3. The LCD module with projection function of claim 2, wherein the reflecting layer of said switching mechanism is driven by said driving mechanism to move between the projection module and the light guide panel, to block light or release light.

4. The LCD module with projection function of claim 3, wherein said projection module is arranged parallelly to the screen of said LCD module.

5. The LCD module with projection function of claim 3, wherein said projection module is arranged perpendicularly to the screen of said LCD module, said backplane is provided with a transparent hole, and light is supplied by said light guide panel to said projection module through the transparent hole.

6. The LCD module with projection function of claim 5, wherein the position of said light guide panel corresponding to said projection module is provided with a chamfer, and the chamfer and the side of said light guide panel are provided with a reflecting layer.

7. The LCD module with projection function of claim 6, wherein the chamfer of said light guide panel is arranged in a non-visual zone.

8. The LCD module with projection function of claim 2, wherein the driving mechanism of said reflecting layer is a manual shift lever, and said reflecting layer is arranged on said manual shift lever.

9. The LCD module with projection function of claim 2, wherein the driving mechanism of said reflecting layer comprises a pair of interworking rack and gear; said reflecting layer is arranged on said rack, and said rack and said reflecting layer are driven by the rotation of said gear to move.

10. The LCD module with projection function of claim 9, wherein said rack is slidably arranged on said backplane.

11. The LCD module with projection function of claim 9, wherein said backplane is a metal backplane; said metal backplane is riveted with a fixing column, and said gear is fixed on said fixing column.

12. The LCD module with projection function of claim 9, wherein, said backplane is a plastic backplane; said plastic backplane is integrated with a fixing column, and said gear is fixed on said fixing column.

13. An LCD device, comprising: an LCD module; said LCD module comprises a light source, a light guide panel, and a backplane, and further comprises a projection module sharing the light source of the LCD module, and a switching mechanism for switching light to the projection module.

14. The LCD device of claim 13, wherein said switching mechanism comprises a reflecting layer for reflecting light supplied by the light source to the projection module back to the light guide panel, and a driving mechanism for controlling the position of said reflecting layer.

15. The LCD device of claim 14, wherein the reflecting layer of said switching mechanism is driven by said driving mechanism to move between the projection module and the light guide panel, to block light or release light.

16. The LCD device of claim 15, wherein said projection module is arranged parallelly to the screen of said LCD module.

17. The LCD device of claim 15, wherein said projection module is arranged perpendicularly to the screen of said LCD module, said backplane is provided with a transparent hole, and light is supplied by said light guide panel to said projection module through the transparent hole.

18. The LCD device of claim 17, wherein the position of said light guide panel corresponding to said projection module is provided with a chamfer, and the chamfer and the side of said light guide panel are provided with a reflecting layer.

19. The LCD device of claim 18, wherein the chamfer of said light guide panel is arranged in a non-visual zone.

20. The LCD device of claim 14, wherein the driving mechanism of said reflecting layer is a manual shift lever, and said reflecting layer is arranged on said manual shift lever.

21. The LCD device of claim 14, wherein the driving mechanism of said reflecting layer comprises a pair of interworking rack and gear; said reflecting layer is arranged on said rack, and said rack and said reflecting layer are driven by the rotation of said gear to move.

22. The LCD device of claim 21, wherein said rack is slidably arranged on said backplane.

23. The LCD device of claim 21, wherein said backplane is a metal backplane; said metal backplane is riveted with a fixing column, and said gear is fixed on said fixing column.

24. The LCD device of claim 21, wherein said backplane is a plastic backplane; said plastic backplane is integrated with a fixing column, and said gear is fixed on said fixing column.
